(19) United States
(12) Patent Application Publication
(10) Pub. No.: US 2004/0046686 A1
(43) Pub. Date: Mar. 11, 2004

(54) Passcode control system for utility vehicle controller

(76) Inventors: James R. Kerlin, Evans, GA (US); Russell W. King, Evans, GA (US); Alan E. Oester, Martinez, GA (US); William E. Shank, Evans, GA (US)

Correspondence Address: MICHAEL BEST & FRIEDRICH LLP, 3773 CORPORATE PARKWAY, SUITE 360, CENTER VALLEY, PA, 18034-8217, US

(21) Appl. No.: 10/391,473

(22) Filed: Mar. 18, 2003

Related U.S. Application Data
(60) Provisional application No. 60/365,341, filed on Mar. 18, 2002.

(51) Int. Cl. H04L 17/02; G08C 19/12; A63H 30/04

(52) U.S. Cl. 341/176; 446/454; 446/456

(57) ABSTRACT

A speed control system for a utility vehicle that includes a motor driven drive system. The control system comprises a controller associated with the motor to control the speed of the vehicle up to a set maximum speed. The maximum speed is set to one of at least two different maximum speed values, including a default lower-speed and a high-speed. An input device is associated with the controller and is configured to change the set maximum speed value to the high-speed value only upon entry of a preset passcode.

This application claims the benefit of U.S. Provisional Patent Application No. 60/365,341 filed Mar. 18, 2002.

### BACKGROUND

The present invention relates to utility vehicles operable in high-speed and lower-speed modes. More particularly, the present invention relates to a passcode protection system for limiting access to the vehicle high-speed mode.

The ANSI Z-130 standard requires that golf car fleets do not exceed a speed of 15 miles per hour (mph) on flat, level ground. Golf cars that are owned by private individuals are not subject to the ANSI Z-130 standard and as such, may be legally operated at speeds up to 20 mph on flat, level ground. There is therefore a desire by private individuals for golf cars that can be inexpensively modified to operate at speeds up to 20 mph. However, while meeting this demand, a means is required to insure that the ANSI Z-130 standard is adhered to by golf cars in fleet applications.

There are several solutions currently employed. One is to physically substitute a high speed (19 mph) electric motor and controller combination for the standard motor and controller. Another method is to physically change the gearing ratio in the vehicle transaxle. Approval procedures are used to insure the customer for this modified vehicle is not required to adhere to the ANSI Z-130 standard. Though generally effective, these solutions are time consuming and costly.

Another solution is to offer an electric motor and controller combination that is designed to operate in several performance modes, one of which is the high-speed private owner mode. The modes are accessed by plug-like devices that physically close different logic circuits. This solution allows for quick and inexpensive access to the high-speed mode, however, the plug-like devices are easily reverse-engineered and duplicated so that they offer little assurance that the ANSI Z-130 standard is met when applicable.

There is a need for a quick and inexpensive method to access the high-speed mode while increasing the difficulty for an unauthorized user to violate the ANSI Z-130 standard.

### SUMMARY

The present invention relates to a speed control system for a utility vehicle that includes a motor driven drive system. The control system comprises a controller associated with the motor to control the speed of the vehicle. The controller is configured to limit the vehicle to a maximum speed. The maximum speed is set to one of at least two different maximum speed values. The values include a high-speed value and a default low speed value. An input device is associated with the controller and is configured to change the maximum speed value to the high-speed value only upon entry of a preset passcode.

### BRIEF DESCRIPTION OF THE DRAWINGS

FIG. 1 is a diagrammatic illustration of a first embodiment of the present invention.

FIG. 2 is a diagrammatic illustration of a second embodiment of the present invention.

FIGS. 3 and 4 illustrate a third embodiment of the present invention.

### DETAILED DESCRIPTION OF THE PREFERRED EMBODIMENTS

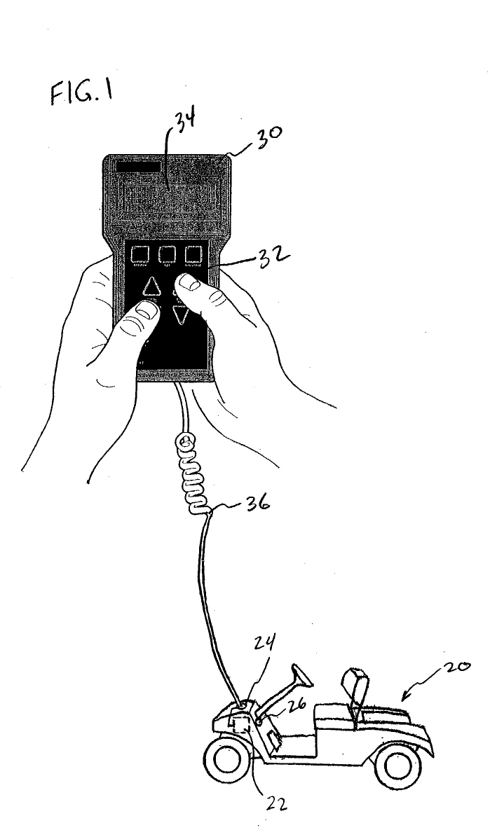

Referring to FIG. 1, an exemplary utility vehicle 20 incorporating the control system that is a first embodiment of the present invention is illustrated. The utility vehicle 20 has a motor (not shown) that drives the vehicle 20. The term motor is used herein in a broad sense and can be a gas engine, an electric motor or the like. In each case, motor speed is controlled by on onboard controller 22.

The controller 22 is preferably a solid-state device containing power semiconductors, an embedded microprocessor, and analog amplifiers for detecting various signals. During normal operation, the controller 22 continuously monitors the input signal from the accelerator pedal to send the appropriate control signals. For example, with a gas powered engine, the controller 22 receives the input signals from the accelerator pedal and then sends the appropriate signal to the fuel system, for example, electrically controlled fuel injectors, to regulate the vehicle speed. In an electric motor, semiconductor switches, such as power field effect transistors (FETs), are used to alternately connect then disconnect the power source to the motor. The controller 22 sends the appropriate control signals to the FETs to regulate the vehicle speed.

The controller 22 is configured to set a maximum speed of the vehicle 20, for example, a maximum fuel injection or a maximum switching of the FETs. The controller 22 is set with a default lower-speed maximum value that meets the ANSI Z-130 standard, for example, a lower-speed maximum value equal to 15 mph. The controller 22 is generally set in the factory with the maximum vehicle speed equal to the lower-speed maximum value. The controller 22 is also set with at least one other maximum value. For example, the controller 22 may be set to have a second, high-speed maximum value equal 20 mph. The controller 22 can be changed to the high-speed maximum value setting only by entering a preset passcode into the controller 22.

The vehicle 20 includes a passcode receiver 24 that is associated with the controller 22. In the embodiment illustrated in FIG. 1, the passcode receiver 24 provides a serial interface for connection of a hand-held input device 30 utilizing a serial cable 36 or the like. The input device 30 includes a key pad 32 and a display screen 34. A user desiring to operate the vehicle 20 at the high-speed maximum value must enter a preset code that is unique to the particular controller 22. The passcodes are preferably generated using a proprietary algorithm that is closely controlled by the vehicle manufacturer, distributor or other controlling party.

In order to receive the unique passcode for the vehicle's controller 22, the user must go through an approval procedure designed to insure that the user is not required to adhere to the ANSI Z-130 standard. An example passcode would comprise three distinct three digit numbers, each of which may range from 000 to 255. Such a passcode system would yield a total of 16,777,215 possible passcodes. To minimize the possibility of an unauthorized user discovering the unique passcode or the manufacturer's algorithm, the controller 22 is preferably configured to allow only a limited number of incorrect passcode entries, for example, 20 attempts, before the controller locks out the high-speed capability. In the event of a lock out, the controller 22 requires resetting by the manufacturer before the high-speed maximum value can be accessed.

The utility vehicle 20 may also be provided with an indicator 26, for example, a single or multicolor light, that displays to the user the mode of the controller 22. For example, a multicolor light may light a first color when the controller 22 is in the lower-speed mode and a second color when the controller 22 is in the high-speed mode. With the single color light, the light illuminates when the controller 22 is in the high-speed mode. In both instances, the indicator 26 allows a facility manager to recognize if anyone has tempered with the controller 22 and improperly set the controller 22 to the high-speed mode.

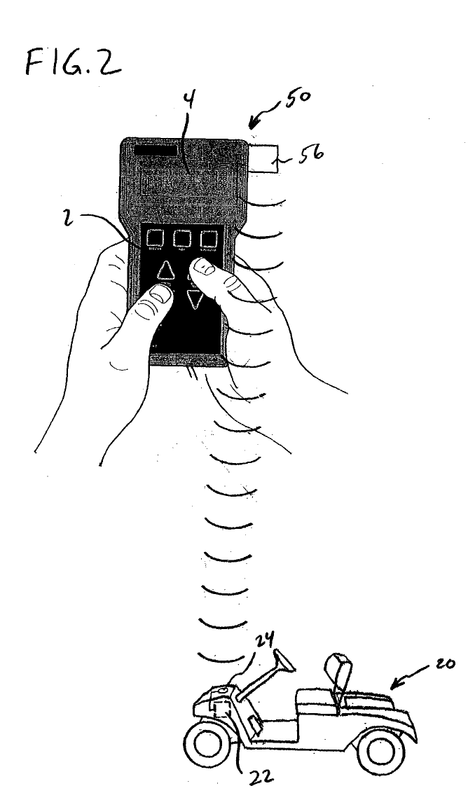

Referring to FIG. 2, a control system which is a second embodiment of the present invention is illustrated. This embodiment is similar to the embodiment of FIG. 1, except that the input device 50 includes a transmitter 56 that communicates with the passcode receiver 24 via wireless technology, for example, using radio frequency or infrared technology. A user still must enter the unique passcode into the controller 22 in order to access the high-speed maximum value.

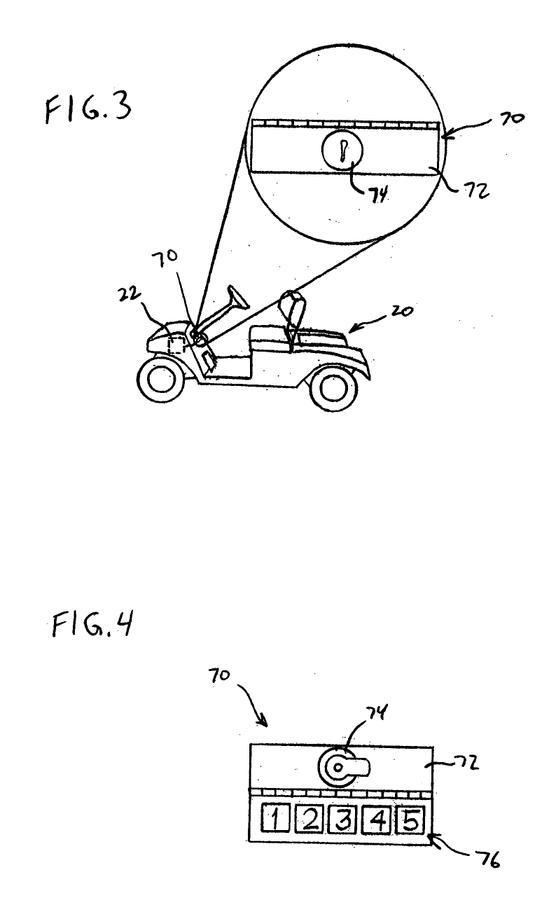

Referring to FIGS. 3 and 4, a control system which is a third embodiment of the present invention is illustrated. This embodiment is similar to the embodiment of FIG. 1, except that the input device 70 is incorporated into the body of the vehicle 22. The input device 70 is preferably protected by a key locked 74 cover 72. The vehicle owner is provided with a key (not shown) to access the input device 70. A key pad 76 is provided inside the cover 72. The user can enter the unique passcode into the controller 22 in order to access the high-speed maximum value. The specific configurations of key pads and displays shown in the various embodiments are for illustration purposes only. Other configurations are also possible without departing from the scope or spirit of the present invention.

What is claimed is:

1. A speed control system for a utility vehicle, the utility vehicle including a motor driven drive system, the control system comprising:
a controller associated with the motor to control the speed of the vehicle up to a maximum speed wherein the controller is configured to set the maximum speed to one of at least two different maximum speed values including a high-speed value and a low speed value, the low-speed value being the default value; and
an input device associated with the controller, the controller configured to change the maximum speed value to the high-speed value only upon entry of a preset passcode into the input device.

2. The control system according to claim 1 wherein the input device includes a hand held key pad.

3. The control system according to claim 2 wherein the hand held key pad includes a serial cable adapted to be connected to a serial connector in communication with the controller.

4. The control system according to claim 2 wherein the hand held key pad includes a radio frequency transmitter adapted to transmit signals to a radio frequency receiver in communication with the controller.

5. The control system according to claim 2 wherein the hand held key pad includes an infrared transmitter adapted to transmit signals to an infrared receiver in communication with the controller.

6. The control system according to claim 1 wherein the controller is configured to prevent changing of the maximum speed value to the high-speed value upon entry of a present number of incorrect passcodes.

7. The control system according to claim 1 further including an indicator associated with the controller such that it provides a user with an indication when the maximum speed value is set to the high-speed value.

8. The control system according to claim 1 wherein the low speed value is equal to 15 miles per hour.

9. The control system according to claim 1 wherein the high-speed value is equal to 20 miles per hour.

10. A utility vehicle comprising:
a vehicle body with a motor driven drive system;
a controller associated with the motor to control the speed of the vehicle up to a maximum speed wherein the controller is configured to set the maximum speed to one of at least two different maximum speed values including a high-speed value and a low speed value, the low-speed value being the default value; and
an input device associated with the controller, the controller configured to change the maximum speed value to the high-speed value only upon entry of a preset passcode into the input device.

11. The utility vehicle according to claim 10 wherein the input device includes a hand held key pad.

12. The utility vehicle according to claim 11 wherein the hand held key pad includes a serial cable adapted to be connected to a serial connector in communication with the controller.

13. The utility vehicle according to claim 11 wherein the hand held key pad includes a radio frequency transmitter adapted to transmit signals to a radio frequency receiver in communication with the controller.

14. The utility vehicle according to claim 11 wherein the hand held key pad includes an infrared transmitter adapted to transmit signals to an infrared receiver in communication with the controller.

15. The utility vehicle according to claim 10 wherein the input device includes a key pad mounted on the vehicle body.

16. The utility vehicle according to claim 15 wherein the key pad is covered by a lockable cover.

17. The utility vehicle according to claim 10 wherein the controller is configured to prevent changing of the maximum speed value to the high-speed value upon entry of a present number of incorrect passcodes.

18. The utility vehicle according to claim 10 further including an indicator associated with the controller such that it provides a user with an indication when the maximum speed value is set to the high-speed value.

19. The utility vehicle according to claim 10 wherein the low speed value is equal to 15 miles per hour.

20. The utility vehicle according to claim 10 wherein the high-speed value is equal to 20 miles per hour.
